(19) United States
(12) Patent Application Publication
(10) Pub. No.: US 2005/0012678 A1
(43) Pub. Date: Jan. 20, 2005

(54) System and method for displaying a parallel panel simultaneously with an RGB panel

(76) Inventors: Yun Shon Low, Richmond (CA); Peter Chia, Port Coquitlam (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/621,596

(22) Filed: Jul. 17, 2003

(51) Int. Cl. G09G 5/00

(52) U.S. Cl. 345/1.1

(57) ABSTRACT

A graphics controller includes circuitry for updating multiple display panels over a shared set of data lines associated with the multiple display panels. The circuitry for updating multiple display panels includes circuitry for generating control signals over control lines dedicated to each of the multiple display panels. A memory region configured to store image data for display on the multiple display panels is included with the circuitry for updating multiple display panels. Circuitry configured to select image data associated with one of the multiple display panels for display during an inactive period associated with an other one of the multiple display panels is provided with the circuitry for updating multiple display panels. A method for displaying image data on an RGB panel and a parallel panel simultaneously is also provided.

### CROSS REFERENCE TO RELATED APPLICATIONS

This application is related to U.S. patent application Ser. No. ______ (Attorney Docket No. VP085), filed on the same day as the instant application and entitled “SYSTEM AND METHOD FOR SHARING GENERAL PURPOSE DATA LINES BETWEEN A DISPLAY PANEL AND NON-DISPLAY DEVICES.” This related application is hereby incorporated by reference for all purposes.

### BACKGROUND OF THE INVENTION

1. Field of the Invention

This invention relates generally to display methods, and more particularly to dual panel display methods for simultaneous display of a parallel panel and an RGB panel.

2. Description of the Related Art

The number of cellular phone users in the U.S. is now estimated at about 17 million and continues to grow at a rate exceeding 20 percent per year. Most of this growth in use has occurred in and around cities and towns with populations of 20,000 or more and has caused saturation of the channels available for cellular communication in many of these urban areas. Cellular service zones servicing about eight-hundred cellular telephone communications have decreased in size from several miles in diameter to a few hundred meters in diameter as the density of cell phone users has increased apace in urban and suburban areas.

To increase market share, cell phone manufactures have increased features available on a cell phone, such as providing a color RGB (red, green, blue) panel display. As will be apparent to those skilled in the art, RGB is a color model used for generating images (still or video) on a display screen. RGB displays colors as varying intensities of red, green and blue dots. FIG. 1 is a block diagram showing a prior art RGB panel configuration 100. The conventional RGB panel configuration 100 includes a graphics controller 102 that provides graphical control for an RGB panel 104. The graphics controller 102 provides image data to the RGB panel 104 using data lines 108, and control signals using control lines 106. As illustrated in FIG. 1, a typical RGB panel configuration 100 uses about four control lines 106 to provide control information, and about eighteen data lines 108 to provide image data to the RGB panel 102.

To increase usability, current cell phone designs often utilize a dual panel display. FIG. 2 is a block diagram showing a conventional dual panel configuration 200. The conventional dual panel configuration 200 includes a graphics controller 202 that provides graphical control for both an RGB panel 104 and a parallel panel 204. In the dual panel configuration 200, the RGB panel 204 generally is utilized as the primary display, while the parallel panel 204 is used as a secondary panel. Similar to above, the graphics controller 202 provides image data to the RGB panel 104 using data lines 108, and control signals using control lines 106. In addition, the graphics controller 202 provides image data to the parallel panel 204 using data lines 208, and control signals using control lines 206.

To display and update the dual panels 204 and 104 simultaneously, the prior art dual panel configuration 200 utilizes two sets of data and control lines. Hence, as above, a typical dual panel configuration 200 uses about four control lines 106 to provide control information, and about eighteen data lines 108 to provide image data to the RGB panel 104. In addition, the dual panel configuration 200 uses about four control lines 206 to provide control information, and about eighteen data lines 208 to provide image data to the parallel panel 204.

Hence, the prior art dual panel configuration 200 requires about forty-four signal lines to provide control and data to the dual display panels 104 and 204. As can be appreciated by those skilled in the art, each signal line requires an input/out (I/O) pad on the graphics controller 202. Thus, forty-four signal lines require forty-four I/O pads on the graphics controller 202, which greatly increases power consumption and routing complexity.

In view of the foregoing, there is a need for a dual panel configuration that allows simultaneous display of both an RGB panel and a parallel panel, which reduces power consumption and routing complexity. To achieve this, the dual panel configuration should require less signal lines yet still provide simultaneous display of both an RGB panel and a parallel panel.

### SUMMARY OF THE INVENTION

Broadly speaking, the present invention fills these needs by providing a dual panel configuration where a shared set of data lines reduces the number of lines without sacrificing the capability to simultaneously support an RGB and a parallel panel. It should be appreciated that the present invention can be implemented in numerous ways, including as a process, a system, or a device. Several inventive embodiments of the present invention are described below.

In one embodiment, a method for displaying image data on an RGB panel and a parallel panel simultaneously is provided. The method initiates with setting an RGB panel to accept image data from a set of data lines. Then, RGB image data is provided to the RGB panel using the set of data lines, wherein the RGB image data is provided at a rate based on an RGB clock. Next, a parallel panel is set to accept image data from the set of data lines. Then, parallel image data is provided to the parallel panel using the set of data lines, wherein the parallel image data is provided at a rate based on a parallel clock.

In another embodiment, a graphics controller is provided. The graphics controller includes circuitry for updating multiple display panels over a shared set of data lines associated with the multiple display panels. The circuitry for updating multiple display panels includes circuitry for generating control signals over control lines dedicated to each of the multiple display panels. A memory region configured to store image data for display on the multiple display panels is included with the circuitry for updating multiple display panels. Circuitry configured to select image data associated with one of the multiple display panels for display during an inactive period associated with an other one of the multiple display panels is provided with the circuitry for updating multiple display panels.

In yet another embodiment, a device is provided. The device includes multiple display panels. A graphics controller configured to drive the multiple display panels over a shared set of data lines is provided. The graphics controller includes circuitry configured to select image data associated with one of the multiple display panels for display during an inactive period associated with an other one of the multiple display panels. A shared clock configured to synchronize image data transfer based upon a clock rate associated with the active period is included.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing a prior art RGB panel configuration;

FIG. 2 is a block diagram showing a convention dual panel configuration;

FIG. 3 is a block diagram showing a dual panel configuration, in accordance with an embodiment of the present invention;

FIG. 4 is a block diagram showing an exemplary graphics controller capable of multiplexing image data between dual display panels, in accordance with an embodiment of the present invention;

FIG. 5 is a signal diagram showing control signals utilized for synchronizing and arbitrating shared data line usage, in accordance with an embodiment of the present invention; and

FIG. 6 is a flowchart showing a method for displaying image data on an RGB panel and a parallel panel simultaneously, in accordance with an embodiment of the present invention.

### DETAILED DESCRIPTION OF THE PREFERRED EMBODIMENTS

An invention is disclosed for a dual panel display configuration for simultaneous display of both an RGB panel and a parallel panel, which reduces power consumption and routing complexity. In general, embodiments of the present invention share a set of data lines for both the RGB panel and a parallel panel, and utilize panel active signals to synchronize and arbitrate data line availability between the two display panels. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

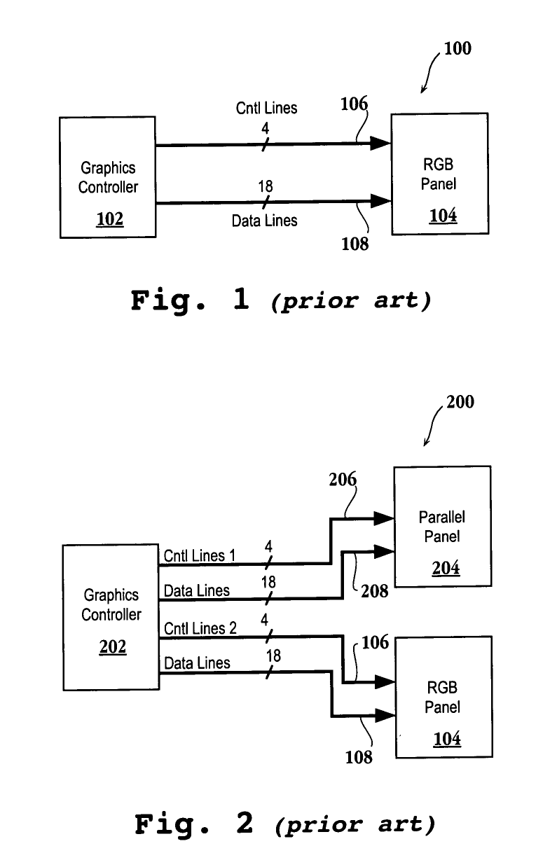

FIGS. 1 and 2 were described in terms of the prior art. FIG. 3 is a block diagram showing a dual panel configuration 300, in accordance with an embodiment of the present invention. The dual panel configuration 300 includes a graphics controller 302 that provides graphical control for both an RGB panel 304 and a parallel panel 306. As above, the RGB panel 304 generally is utilized as the primary display, while the parallel panel 306 is used as a secondary panel, however, it should be noted that this is not required. The graphics controller 302 provides control signals to the RGB panel 304 using control lines 308. In addition, graphics controller 302 provides control signals to the parallel panel 306 using control lines 310.

To reduce the number of signal lines required in the dual panel configuration 300, embodiments of the present invention utilize shared data lines 312 to provide image data to both the RGB panel 304 and the parallel panel 306. Hence, embodiments of the present invention utilize about four control lines 308 to provide control information to the RGB panel 304, and another four control lines 310 to provide control information to the parallel panel 306. However, unlike conventional dual panel configurations, embodiments of the present invention utilize about eighteen data lines 312 to provide image data to both the RGB panel 304 and the parallel panel 306.

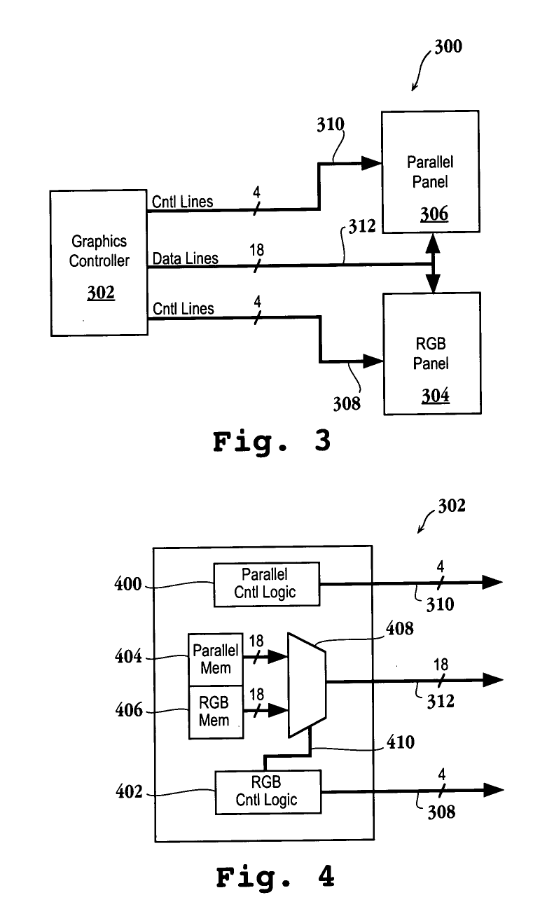

In operation, the graphics controller 302 provides clock signals, synchronization signals, on/off signals, and other control information to the RGB panel 304 and the parallel panel 306 using separate control lines 308 and 310. In addition, image data is multiplexed between the RGB panel 304 and the parallel panel 306 using the shared data lines 308, as illustrated next with reference to FIG. 4.

FIG. 4 is a block diagram showing an exemplary graphics controller 302 capable of multiplexing image data between dual display panels, in accordance with an embodiment of the present invention. The graphics controller 302 includes parallel control logic 400, which provides control signals to the control lines 310 for the parallel panel, and RGB control logic 402, which provides control signals to the control lines 308 for the RGB panel. The control signals include control information such as clock signals, synchronization signals, and on/off signals.

Image data for the parallel panel is stored in a parallel graphics memory 404, and image data for the RGB panel is stored in an RGB graphics memory 406. The image data from both the parallel graphics memory 404 and the RGB graphics memory 406 is provided to a graphics multiplexer 408, which selects which image data to place on the shared data lines 312 at any particular time. In one embodiment, image data selection is provided via an RGB select signal 410 provided by the RGB control logic 402. In operation, when the RGB control logic 402 determines the image data for the RGB panel should be placed on the shared data lines 312, the RGB select signal 410 is asserted such that the graphics multiplexer 408 selects the image data stored in the RGB memory 406. When the image data for the RGB panel should not be placed on the shared data lines 312, the RGB control logic 402 sets the RGB select signal 410 such that the graphics multiplexer 408 selects the image data stored in the parallel memory 404.

Although FIG. 4 illustrates image data selection using an RGB select signal 410, it should be noted that the image data select signal can come from any source. For example, the image data selection can be provided via a parallel select signal provided by the parallel control logic 400, or image data selection can be provided by other selection logic capable of determining when data for each panel should be placed on the shared data lines 312.

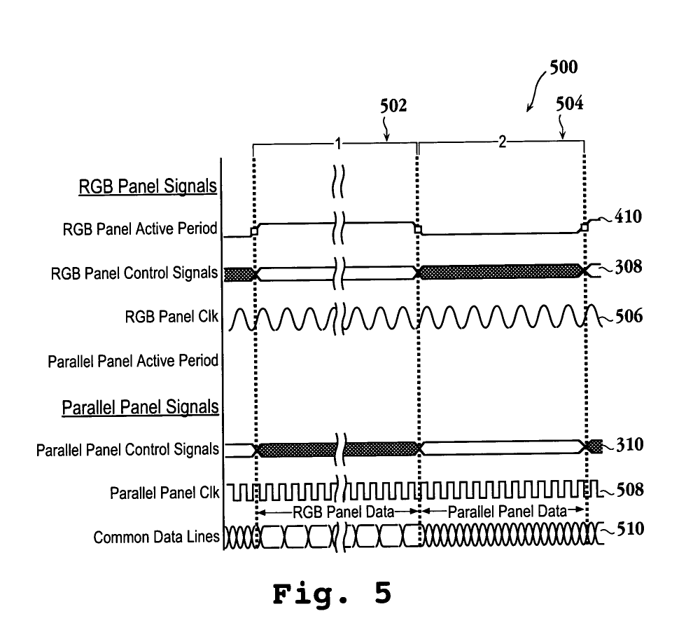

FIG. 5 is a signal diagram 500 showing control signals utilized for synchronizing and arbitrating shared data line usage, in accordance with an embodiment of the present invention. The signal diagram 500 shows the RGB select signal 410, RGB control signals 308, and an RGB clock signal 506. The signal diagram 500 also shows the parallel control signals 310 and a parallel clock signal 508. In addition, signal diagram 500 shows a shared data line clock 510.

The signal diagram 500 illustrates two periods, an RGB active period 502 and an RGB non-active period 504, which are based on the RGB select signal 410. In one embodiment, the RGB select signal 410 can be an RGB resynchronization signal. The RGB panel has a display period and a non-display period, which is based on a resynchronization signal. When the resynchronization signal is high, the RGB panel enters a display period, and when the resynchronization signal is low, the RGB panel enters a non-display period. During the display period, embodiments of the present invention provide image data to the RGB panel, while during the non-display period of the RGB panel, embodiments of the present invention utilize the shared data lines to provide data to the parallel panel.

As shown in FIG. 5, during period 502, the RGB select signal 410 is high. As mentioned above, when the RGB select signal 410 is high, the RGB panel enters a display period and the parallel panel enters a non-display period. Specifically, when the RGB select signal 410 is high, the RGB control signals 308 are set such that the RGB panel will accept data from the shared data lines. In addition, the parallel control signals 310 are set such that the parallel panel will not accept data from the shared data lines. To synchronize the image data transfer to the RGB panel, the shared data clock 510 is set to a rate based on the RGB clock 506 during period 502. In this manner, the RGB panel can be updated using the shared data lines, while the parallel panel continues to display image data based on the parallel panel last update.

Subsequently, during period 504, the RGB select signal 410 is low indicating a non-display period for the RGB panel. As mentioned above, when the RGB select signal 410 is low, the RGB panel enters a non-display period and the parallel panel enters a display period. Thus, when the RGB select signal 410 is low, the RGB panel control signals 308 are set such that the RGB panel will not accept data from the shared data lines, while the parallel panel control signals 310 are set such that the parallel panel will accept data from the shared data lines. To synchronize the image data transfer to the parallel panel, the shared data clock 510 is set to a rate based on the parallel clock 508 during period 504. In this manner, the parallel panel can be updated using the shared data lines, while the RGB panel continues to display image data based on the parallel panel last update. This sequence of display and non-display periods is repeated to allow interlaced updates to each display panel, thus providing the appearance of simultaneous update and display of image data on each panel.

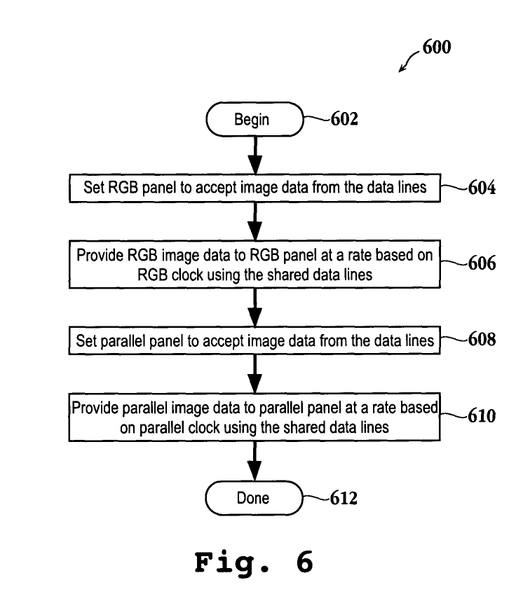

FIG. 6 is a flowchart showing a method 600 for displaying image data on an RGB panel and a parallel panel simultaneously, in accordance with an embodiment of the present invention. In an initial operation 602, preprocess operations are performed. Preprocess operations can include, for example, providing and/or generating image data, storing image data to the RGB memory and the parallel memory, and other preprocess operations that will be apparent to those skilled in the art.

In operation 604, the RGB panel is set to accept image data from the shared data lines. Turning to FIG. 4, image data for the parallel panel is stored in a parallel graphics memory 404, and image data for the RGB panel is stored in an RGB graphics memory 406. The image data from both the parallel graphics memory 404 and the RGB graphics memory 406 is provided to a graphics multiplexer 408, which selects which image data to place on the shared data lines 312 at any particular time based on an RGB select signal 410 provided by the RGB control logic 402.

As mentioned previously, when the RGB select signal is high, the RGB control signals are set such that the RGB panel will accept data from the shared data lines. The RGB select signal may be an RGB resynchronization signal, which determines when the RGB panel has entered the display period and the non-display period. When the resynchronization signal is high, the RGB panel enters a display period, and when the resynchronization signal is low, the RGB panel enters a non-display period. During the display period, embodiments of the present invention provide image data to the RGB panel. In addition, the parallel control signals are set such that the parallel panel will not accept data from the shared data lines.

Referring back to FIG. 6, RGB image data is provided to the RGB panel at a rate based on the RGB clock using the shared data lines, in operation 606. As shown in FIG. 4, when the RGB control logic 402 determines the image data for the RGB panel should be placed on the shared data lines 312, the RGB select signal 410 is asserted such that the graphics multiplexer 408 selects the image data stored in the RGB memory 406. To synchronize the image data transfer to the RGB panel, the shared data clock is set to rate based on the RGB clock. In this manner, the RGB panel can be updated using the shared data lines, while the parallel panel continues to display image data based on the parallel panel last update.

Returning to FIG. 6, the parallel panel is set to accept image from the data lines, in operation 608. As mentioned previously, when the RGB select signal is low, the RGB control signals are set such that the RGB panel will not accept data from the shared data lines. During the non-display period of the RGB panel, embodiments of the present invention utilize the shared data lines to provide data to the parallel panel. In addition, the RGB control signals are set such that the RGB panel will not accept data from the shared data lines.

Parallel image data is provided to the parallel panel at a rate based on the parallel clock using the shared data lines, in operation 610. Referring to FIG. 4, when the RGB control logic 402 determines the image data for the parallel panel should be placed on the shared data lines 312, the RGB select signal 410 is set such that the graphics multiplexer 408 selects the image data stored in the parallel memory 404. To synchronize the image data transfer to the RGB panel, the shared data clock is set to a rate based on the parallel clock. In this manner, the parallel panel can be updated using the shared data lines, while the RGB panel continues to display image data based on the parallel panel last update. Post process operations are performed in operation 612. Post process operation can include, for example, additional updates to the image data stored in the parallel and RGB memories, additional changing of the RGB select signal, and other operations that will be apparent to those skilled in the art after a careful reading of the present disclosure.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for displaying image data on an RGB panel and a parallel panel simultaneously, comprising the operations of:
setting an RGB panel to accept image data from a set of data lines;
transmitting RGB image data to the RGB panel using the set of data lines, wherein the RGB image data is transmitted at a rate based on an RGB clock;
setting a parallel panel to accept image data from the set of data lines; and
transmitting parallel image data to the parallel panel using the set of data lines, wherein the parallel image data is transmitted at a rate based on a parallel clock.

2. The method of claim 1, wherein the RGB panel is set to decline image data from a set of data lines when the parallel panel is set to accept image data from the set of data lines, and wherein the parallel panel is set to decline image data from a set of data lines when the RGB panel is set to accept image data from the set of data lines.

3. The method of claim 2, wherein the RGB panel is set to accept image data from the set of data lines when an RGB select signal is high.

4. The method of claim 3, wherein the RGB select signal is an RGB resynchronization signal.

5. The method of claim 1, further comprising:
synchronizing image data transfer to the RGB panel and the parallel panel.

6. The method of claim 5, wherein the method operation of synchronizing image data transfer to the RGB panel and the parallel panel includes,
establishing a shared data clock;
determining if the RGB panel active;
if the RGB panel is active, the method includes,
setting a rate of the shared data clock to correspond to a rate of the RGB clock and;
if the RGB panel is inactive, the method includes,
setting a rate of the shared data clock to correspond to a rate of the parallel clock.

7. A graphics controller, comprising:
circuitry for updating multiple display panels over a shared set of data lines associated with the multiple display panels, the circuitry for updating multiple display panels includes,
circuitry for generating control signals over control lines dedicated to each of the multiple display panels;
a memory region configured to store image data for display on the multiple display panels; and
circuitry configured to select image data associated with one of the multiple display panels for display during an inactive period associated with an other one of the multiple display panels.

8. The graphics controller of claim 7, wherein the multiple panels include a single RGB panel and a single parallel panel.

9. The graphics controller of claim 7, further comprising:
circuitry configured to synchronize image data transfer according to a clock associated with an active one of the multiple display panels.

10. The graphics controller of claim 7, wherein the circuitry configured to select image data associated with one of the multiple display panels for display during an inactive period associated with an other one of the multiple display panels includes,
a multiplexer configured to select data for one of a parallel panel and a RGB panel.

11. The graphics controller of claim 7, wherein the shared set of data lines includes eighteen data lines.

12. The graphics controller of claim 7, wherein the memory region provides all memory support for each of the multiple display panels.

13. The graphics controller of claim 9, wherein the circuitry configured to synchronize image data transfer according to a clock associated with an active one of the multiple display panels is further configured to select image data from the memory region according to the circuitry for generating the control signals.

14. A device, comprising:
multiple display panels;
a graphics controller configured to drive the multiple display panels over a shared set of data lines, the graphics controller including circuitry configured to select image data associated with one of the multiple display panels for display during an inactive period associated with an other one of the multiple display panels; and
a shared clock configured to synchronize image data transfer based upon a clock rate associated with the active period.

15. The device of claim 14, wherein the multiple display panels includes a RGB panel and a parallel panel.

16. The device of claim 14, wherein each of the multiple display panels is associated with a different clock rate.

17. The device of claim 14, where a number of shared data lines is eighteen.

18. The device of claim 14, wherein the device is a cellular phone having a primary panel and a secondary panel.

19. The device of claim 14, wherein the graphics controller further includes,
a memory shared by each of the multiple display panels.

20. The device of claim 14, wherein the circuitry configured to select image data includes control logic configured to generate control signals associated with the one of the multiple display panels.
